(19) United States
(12) Patent Application Publication
(10) Pub. No.: US 2025/0150308 A1
(43) Pub. Date: May 8, 2025

(54) SYSTEMS AND METHODS FOR DECODING IN WIRELESS COMMUNICATIONS

(71) Applicant: Samsung Electronics Co., Ltd., Suwon-si, Gyeonggi-do (KR)

(72) Inventors: Mojtaba RAHMATI, San Diego, CA (US); Hyuk Joon KWON, San Diego, CA (US); Dongwoon BAI, San Diego, CA (US)

(21) Appl. No.: 18/907,137

(22) Filed: Oct. 4, 2024

Related U.S. Application Data
(60) Provisional application No. 63/547,298, filed on Nov. 3, 2023.

(51) Int. Cl. H04L 25/02

(52) U.S. Cl. CPC H04L 25/024; H04L 25/0224

(57) ABSTRACT

A system and a method are disclosed for decoding in wireless communications. In some embodiments, a method includes receiving a reference signal; generating a channel estimate, based on the reference signal; determining a channel estimation error metric for the channel estimate; receiving a transmission; calculating a log likelihood ratio, based on the channel estimation error metric, for each of a plurality of bit positions of the transmission; and decoding the transmission based on the log likelihood ratio. The calculating of the log likelihood ratio may include calculating a corrected log likelihood ratio based at least on an uncorrected log likelihood ratio.

### CROSS-REFERENCE TO RELATED APPLICATION

This application claims the priority benefit under 35 U.S.C. § 119 (e) of U.S. Provisional Application No. 63/547,298, filed on Nov. 3, 2023, the disclosure of which is incorporated by reference in its entirety as if fully set forth herein.

### TECHNICAL FIELD

The disclosure generally relates to wireless communication. More particularly, the subject matter disclosed herein relates to improvements to systems and methods for decoding in wireless communications.

### SUMMARY

When a digital signal is received over a wireless channel, soft decision decoding may be employed to decode the received data, in units that may be referred to as code blocks. The decoding may involve calculating the likelihood that each transmitted bit was a zero or a one. This likelihood may be represented as a log likelihood ratio. The estimating may, however, be based on an estimate of the channel (e.g., of the channel response (e.g., an impulse response or a frequency response of the channel)), which may not be known a priori. The channel estimate may be generated, for example, by taking the ratio of a Fourier transform of the received signal to the Fourier transform of the transmitted signal (which may be a known reference signal).

To solve this problem, a channel estimate may be generated.

One issue with the above approach is that the channel estimate may be imperfect, and that errors in the channel estimate may result in a bias in the calculated log likelihood ratio.

To overcome these issues, systems and methods are described herein for log likelihood calculation in the presence of channel estimation error.

The above approaches improve the performance of a system using such approaches, as they provide improved log likelihood values (e.g., values with reduced bias) in the presence of channel estimation errors than methods that do not take channel estimation error into account. Further, the above approaches may result in improved log likelihood ratios, which may be used to improve decoding performance.

According to an embodiment of the present disclosure, there is provided a method, including: receiving a reference signal; generating a channel estimate, based on the reference signal; determining a channel estimation error metric for the channel estimate; receiving a transmission; calculating a log likelihood ratio, based on the channel estimation error metric, for each of a plurality of bit positions of the transmission; and decoding the transmission based on the log likelihood ratio, wherein the calculating of the log likelihood ratio includes calculating a corrected log likelihood ratio based at least on an uncorrected log likelihood ratio.

In some embodiments, the corrected log likelihood ratio is further equal to the uncorrected log likelihood ratio further adjusted by one or more correction mappings.

In some embodiments, a first correction mapping of the correction mappings is based on a multiplicative correction mapping.

In some embodiments, the first correction mapping of the correction mappings includes multiplication by 2 raised to the power of an integer.

In some embodiments, the method further includes storing the log likelihood ratio in a fixed-point representation, the fixed-point representation having a binary point position calculated based on a first term and a second term, the second term being the integer.

In some embodiments, the first correction mapping is based on a rank of the transmission.

In some embodiments, the first correction mapping is based on the channel estimation error metric.

In some embodiments, the channel estimation error metric is based on a ratio of a channel estimation error power to a noise power.

In some embodiments, the determining of the channel estimation error metric includes determining the channel estimation error power based on a weight for time domain interpolation.

In some embodiments, the determining of the channel estimation error metric includes determining the channel estimation error power further based on a correlation time of a channel response of a channel corresponding to the channel estimation error.

According to an embodiment of the present disclosure, there is provided a system, including: one or more processors; and a memory storing instructions which, when executed by the one or more processors, cause performance of: receiving a reference signal; generating a channel estimate, based on the reference signal; determining a channel estimation error metric for the channel estimate; receiving a transmission; calculating a log likelihood ratio, based on the channel estimation error metric, for each of a plurality of bit positions of the transmission; and decoding the transmission based on the log likelihood ratio, wherein the calculating of the log likelihood ratio includes calculating a corrected log likelihood ratio based at least on an uncorrected log likelihood ratio.

In some embodiments, the corrected log likelihood ratio is further equal to the uncorrected log likelihood ratio further adjusted by one or more correction mappings.

In some embodiments, a first correction mapping of the correction mappings is based on a multiplicative correction mapping.

In some embodiments: the first correction mapping of the correction mappings includes multiplication by 2 raised to the power of an integer; and the instructions, when executed by the one or more processors, further cause performance of storing the log likelihood ratio in a fixed-point representation, the fixed-point representation having a binary point position calculated based on a first term and a second term, the second term being the integer.

In some embodiments, the first correction mapping is based on a rank of the transmission.

In some embodiments, the first correction mapping is based on the channel estimation error metric.

In some embodiments, the channel estimation error metric is based on a ratio of a channel estimation error power to a noise power.

In some embodiments, the determining of the channel estimation error metric includes determining the channel estimation error power based on a weight for time domain interpolation.

In some embodiments, the determining of the channel estimation error metric includes determining the channel estimation error power further based on a correlation time of a channel response of a channel corresponding to the channel estimation error.

According to an embodiment of the present disclosure, there is provided a system, including: means for processing; and a memory storing instructions which, when executed by the means for processing, cause performance of: receiving a reference signal; generating a channel estimate, based on the reference signal; determining a channel estimation error metric for the channel estimate; receiving a transmission; calculating a log likelihood ratio, based on the channel estimation error metric, for each of a plurality of bit positions of the transmission; and decoding the transmission based on the log likelihood ratio, wherein the calculating of the log likelihood ratio includes calculating a corrected log likelihood ratio based at least on an uncorrected log likelihood ratio.

### BRIEF DESCRIPTION OF THE DRAWINGS

In the following section, the aspects of the subject matter disclosed herein will be described with reference to exemplary embodiments illustrated in the figures, in which:

FIG. 1 shows a system including a User Equipment (UE) and a network node (gNB) in communication with each other, according to an embodiment.

FIG. 2 is a flow chart, according to an embodiment.

FIG. 3 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

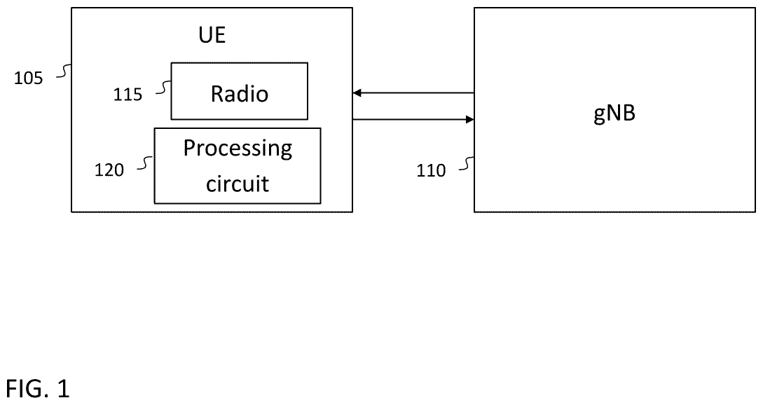

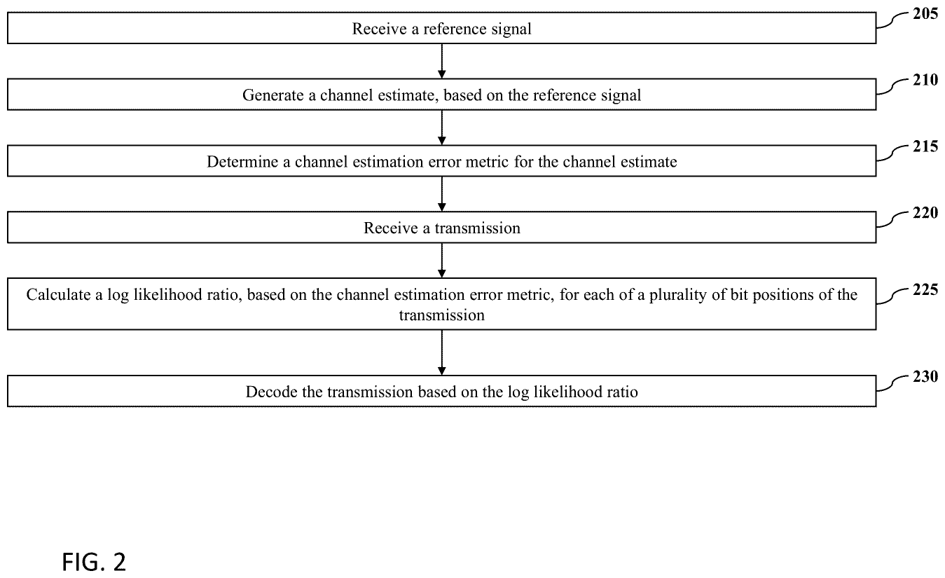

FIG. 1 shows a system including a user equipment (UE) 105 and a network node (gNB) 110, in communication with each other. The UE 105 may be a user device capable of connecting to a wireless network (e.g., a fifth generation (5G) cellular network), e.g., a mobile telephone, or a laptop or tablet computer capable of accessing the wireless network. The UE 105 may include a radio 115 and a processing circuit (or a means for processing) 120, which may perform various methods disclosed herein, e.g., the method illustrated in FIG. 2. For example, the processing circuit 120 may receive, via the radio 115, transmissions from the network node (gNB) 110, and the processing circuit 120 may transmit, via the radio 115, signals to the gNB 110.

In operation, the UE 105 may receive (i) a reference signal (e.g., a demodulation reference signal (DMRS)) and (ii) data transmissions (e.g., physical downlink shared channel (PDSCH) transmissions) from the gNB 110. The UE 105 may (i) perform noise estimation and channel estimation (CE) based on the received DMRS and (ii) calculate a log likelihood ratio for each bit of one of the other transmissions using the estimated noise and the channel estimate (e.g., the estimated channel characteristics resulting from the process of channel estimation). The channel estimate may include a frequency domain or time domain representation of the channel as a linear system (e.g., it may include or consist of the impulse response of the channel or the frequency response of the channel). For example, the frequency response of the channel may include the effects of frequency-dependent attenuation (as may occur as a result of diffraction around an obstruction or as a result of ripple caused by multipath). Similarly, in the presence of multipath, the impulse response of the channel may include a plurality of peaks corresponding to different paths the signal may take from the transmitter to the receiver. The UE 105 may then decode the other transmission using the log likelihood ratios. The calculated log likelihood ratios may however be biased (and therefore less accurate than they would be in the absence of such bias) because of errors in the channel estimate. As such, improved log likelihood ratios, calculated using methods disclosed herein, may be used to improve decoding performance.

The connection between the UE 105 and the gNB 110 may be a multiple-input-multiple-output orthogonal frequency division multiplexed (MIMO-OFDM) system, with a system model of

$$y = Hx + n {\sum }_{j = 0}^{L - 1} {h}_{j} {x}_{j} + n$$

where H=[h₀ . . . h_{L-1}] is the channel impulse response for all layers, hᵢ is the channel impulse response for the i^{th} layer, and n is the noise, with L denoting the number of transmission layers, nᵣ denoting the number of receive antennas and n˜N(0, σₙ²Iₙ_{ᵣ}_{×n}_{ᵣ}), where N is a normal distribution.

The channel estimation error matrix may be defined as E=[e₀ . . . e_{L-1}] where eᵢ is the channel estimation error for the i^{th} layer, and ĥⱼ=hⱼ+eⱼ with

$$E \{ {e}_{j , i} \} = 0$$

$$and$$

$$E \{ {e}_{j} {e}_{j}^{H} \} = {σ}_{e}^{2} I .$$

Therefore, the received signal at PDSCH resource elements (REs) may be expressed as a function of the estimated channel ĥⱼ, the CE error eⱼ, and the noise as

$$y = \hat{H} x - Ex + n = {\sum }_{j = 0}^{L - 1} {\hat{h}}_{j} {x}_{j} - {\sum }_{j = 0}^{L - 1} {e}_{j} {x}_{j} + n .$$

Since the channel estimate is obtained from DMRS REs, the eⱼ's are independent of the noise realizations at the PDSCH REs (the CE errors eⱼ are correlated with the noise at DMRS REs), i.e.,

$$E \{ {e}_{j} {n}^{H} \} = 0.$$

Additionally, assuming linear minimum mean square estimation (LMMSE) channel estimation is utilized, the CE errors (the eⱼ's) are orthogonal to the channel estimates, i.e.,

$$E \{ {e}_{j} {\hat{h}}_{k}^{H} \} = 0.$$

Therefore, approximating eⱼ as white Gaussian with eⱼ˜N(0, σₑ²Iₙ_{ᵣ}_{×n}_{ᵣ}) and defining

$$\tilde{n} = n - {\sum }_{j = 0}^{L - 1} {e}_{j} {x}_{j} ,$$

it follows that

$$y = {\sum }_{j = 0}^{L - 1} {\hat{h}}_{j} {x}_{j} + \tilde{n}$$

with

$$\tilde{n} \sim N ( 0 , {σ}_{n}^{2} ( 1 + λ {\vert x \vert}^{2} ) {I}_{{n}_{r} \times {n}_{r}} ) ,$$

where Iₙ_{ᵣ}_{×n}_{ᵣ} is an nᵣ×nᵣ identity matrix,

$${\vert x \vert}^{2} = {\sum }_{j = 0}^{L - 1} {\vert {x}_{j} \vert}^{2} and λ = \frac{{σ}_{e}^{2}}{{σ}_{n}^{2}} .$$

The LLRs may be written

$$LLR ( {b}_{k , n} ) = log ( \frac{{\sum }_{x ∈ {𝒳}_{k , n}^{-}} \frac{1}{{( {σ}_{n}^{2} + {σ}_{e}^{2} {\vert x \vert}^{2} )}^{{n}_{r}}} exp ( \frac{{\vert y - \hat{H} x \vert}^{2}}{{σ}_{n}^{2} ( 1 + λ {\vert x \vert}^{2} )} )}{{\sum }_{x ∈ {𝒳}_{k , n}^{+}} \frac{1}{{( {σ}_{n}^{2} + {σ}_{e}^{2} {\vert x \vert}^{2} )}^{{n}_{r}}} exp ( \frac{{\vert y - \hat{H} x \vert}^{2}}{{σ}_{n}^{2} ( 1 + λ {\vert x \vert}^{2} )} )} )$$

Finally, by applying the max log map (MLM) approximation, the LLRs are obtained as

$$LLR ( {b}_{k , n} ) = {min}_{x ∈ {𝒳}_{k , n}^{+}} ( \frac{{\vert y - \hat{H} x \vert}^{2}}{{σ}_{n}^{2} ( 1 + λ {\vert x \vert}^{2} )} + {n}_{r} \times log ( 1 + λ {\vert x \vert}^{2} ) ) - {min}_{x ∈ {𝒳}_{k , n}^{-}} ( \frac{{\vert y - \hat{H} x \vert}^{2}}{{σ}_{n}^{2} ( 1 + λ {\vert x \vert}^{2} )} + {n}_{r} \times log ( 1 + λ {\vert x \vert}^{2} ) ) \qquad ( 1 )$$

In some embodiments, the full Euclidean distance (ED) is used to calculate the log likelihood ratio. As shown in Equation 1, an LLR calculation that fully incorporates the CE error power may be written

$$L L R ( {b}_{k , n} ) = {min}_{x ∈ {χ}_{k , n}^{+}} ( \frac{{\vert y - \hat{H} x \vert}^{2}}{{σ}_{n}^{2} ( 1 + λ {\vert x \vert}^{2} )} + {n}_{r} \times log ( 1 + λ {\vert x \vert}^{2} ) ) - {min}_{x ∈ {χ}_{k , n}^{-}} ( \frac{{\vert y - \hat{H} x \vert}^{2}}{{σ}_{n}^{2} ( 1 + λ {\vert x \vert}^{2} )} + {n}_{r} \times log ( 1 + λ {\vert x \vert}^{2} ) ) \qquad ( 2 )$$

For rank-2 MIMO detection, LLRs can be obtained as

$$L L R ( {b}_{k , 0} ) = {min}_{{x}_{0} ∈ {χ}_{k}^{+}} ( \frac{{min}_{{x}_{1} ∈ χ} {\vert y - {\hat{h}}_{0} {x}_{0} - {\hat{h}}_{1} {x}_{1} \vert}^{2}}{{σ}_{n}^{2} ( 1 + λ {\vert x \vert}^{2} )} + {n}_{r} log ( 1 + λ {\vert x \vert}^{2} ) ) - {min}_{{x}_{0} ∈ {χ}_{k}^{-}} ( \frac{{min}_{{x}_{1} ∈ χ} {\vert y - {\hat{h}}_{0} {x}_{0} - {\hat{h}}_{1} {x}_{1} \vert}^{2}}{{σ}_{n}^{2} ( 1 + λ {\vert x \vert}^{2} )} + {n}_{r} log ( 1 + λ {\vert x \vert}^{2} ) ) \qquad ( 3 )$$

As used herein, the “rank” is the number of spatial channels used in a MIMO system. For example, in a system with two transmitting antennas and two receiving antennas, the rank may be 1 (if, e.g., poor channel conditions are adversely affecting one of the spatial streams) or 2 (when favorable channel conditions are present). Euclidean distance scaling may be performed as follows. As shown in Equation 3, full ED adjustment may involve applying two corrections (or “correction mappings”) over legacy ED calculations (where “legacy ED calculations” refers to Euclidean distance calculations not including these corrections): (i) scaling (e.g., applying a multiplicative correction mapping to) the legacy ED, and (ii) applying an offset correction (e.g., an additive correction mapping) to the scaled ED values. As used herein, a “correction mapping” is a mapping from an uncorrected value to a corrected value. In some circumstances, however, the gain from using an additive correction mapping may be relatively small and ED scaling (the use of a multiplicative correction mapping) is the correction mapping responsible for most of the performance improvement. Therefore, in some embodiments, only ED scaling is used. The equation for the LLRs may then be written in the following lower-complexity form:

$$L L R ( {b}_{k , 0} ) = {min}_{{x}_{0} ∈ {χ}_{k}^{+}} ( \frac{{min}_{{x}_{1} ∈ χ} {\vert y - {\hat{h}}_{0} {x}_{0} - {\hat{h}}_{1} {x}_{1} \vert}^{2}}{{σ}_{n}^{2} ( 1 + λ {\vert x \vert}^{2} )} ) - {min}_{{x}_{0} ∈ {χ}_{k}^{-}} ( \frac{{min}_{{x}_{1} ∈ χ} {\vert y - {\hat{h}}_{0} {x}_{0} - {\hat{h}}_{1} {x}_{1} \vert}^{2}}{{σ}_{n}^{2} ( 1 + λ {\vert x \vert}^{2} )} ) \qquad ( 4 )$$

Even though ED scaling reduces the complexity of taking the CE error power into account in calculating the LLR, the use of this solution may nonetheless involve significant hardware complexity.

As such, to avoid calculating the full Euclidean distance and to avoid per-ED scaling, the average scaling over the final calculated LLRs, in the form of E{1+λ|x|²}=1+rank×λ, may be used as a multiplicative correction factor (in a multiplicative correction mapping) for all x∈χ_{k,n}⁺ and all x∈χ_{k,n}⁻ Therefore, the final LLR can be obtained as

$$L L R ( {b}_{k , n} ) = \frac{{min}_{x ∈ {χ}_{k , n}^{+}} {\vert y - \hat{H} x \vert}^{2} - {min}_{x ∈ {χ}_{k , n}^{-}} {\vert y - \hat{H} x \vert}^{2}}{{σ}_{n}^{2} ( 1 + λ \times rank )} \qquad ( 5 )$$

In Equation 5, the factor

$$( {min}_{x ∈ {χ}_{k , n}^{+}} {\vert y - \hat{H} x \vert}^{2} - {min}_{x ∈ {χ}_{k , n}^{-}} {\vert y - \hat{H} x \vert}^{2} ) / {σ}_{n}^{2}$$

may be considered to be an uncorrected log likelihood ratio, which is adjusted by a multiplicative correction mapping using a correction factor of

$$( \frac{1}{( 1 + λ \times rank )} )$$

to reduce or eliminate CE-error-related bias in the calculated log likelihood ratio. It may be seen that such a multiplicative correction mapping is based on (e.g., depends on) (i) the rank and on (ii) the ratio λ of the channel estimation error power to the noise power.

Depending on modulation order and the bit position k,

$${E}_{x ∈ {χ}_{k , n}^{+}} \{ {\vert x \vert}^{2} \} = {E}_{x ∈ {χ}_{k , n}^{-}} \{ {\vert x \vert}^{2} \}$$

does not necessarily hold; however, to avoid per-ED scaling, the final scaling may nonetheless be approximated as 1+λE{|x|²}=1+rank×λ.

The complexity of the calculation of the log likelihood ratio may be further reduced by using a multiplicative correction factor (in a multiplicative correction mapping) that is equal to (e.g., rounded to be equal to) 2 raised to the power of an integer, e.g., by replacing the LLR scaling with a simple bit shift (which may correspond to multiplying by a power of 2). For example

$$L L R ( {b}_{k , n} ) = \frac{{2}^{{q}_{2}}}{{σ}_{n}^{2}} ( {min}_{x ∈ {χ}_{k , n}^{-}} {\vert y - \hat{H} x \vert}^{2} - {min}_{x ∈ {χ}_{k , n}^{-}} {\vert y - \hat{H} x \vert}^{2} )$$

where the rounding of the multiplicative correction factor may be written

$${q}_{2} = - round ( {log}_{2} ( 1 + rank \times λ ) ) .$$

A benefit of applying the LLR scaling in the form of a simple bit shift is that the bit shift of q₂ may be applied as part of the final q-factor (a factor used to determine the position of the binary point in a fixed-point representation of the log likelihood ratio). For example, the q-factor may be written as the sum of two parts, q₁ and q₂, as

$$q = {q}_{1} + {q}_{2}$$

where q₂ is obtained as a function of the CE error and q₁ is the remaining tuning factor. The q factor (q) may be used to determine the position of the binary point in a fixed-point representation of the log likelihood ratio. For example, the log likelihood ratio may be stored in a fixed-point representation, the fixed-point representation having a binary point position calculated as a sum of a first term (q₁) and a second term (q₂), where the second term is the integer to the power of which 2 is raised, when the multiplicative correction factor is equal to 2 raised to the power of an integer, as discussed above.

A difficulty in tuning the q factor is that q is a function of several parameters such as rank, signal to noise ratio (SNR), Doppler spread, Delay spread, subcarrier spacing (SCS) and modulation order, e.g.,

$$q = func ( rank , SNR , Dopp , DS , SCS , Mod ) .$$

However, as shown above, the impact of the CE error power may be incorporated in the form of an LLR bit shift, which may be applied as part of the q-factor. For example, the q-factor may be written as the sum of two parts, q₁ and q₂, as q=q₁+q₂ where

$${q}_{2} = {func}_{1} ( rank , SNR , Dopp , DS , S C S ) = - round ( {log}_{2} ( 1 + rank \times λ ) ) \qquad ( 6 )$$

When this is done, the remaining part of q, i.e., q₁, may, as determined by simulation, act as a function of rank, SNR and modulation order only:

$${q}_{1} = func ( rank , SNR , Mod ) .$$

The absence of a dependence on Doppler spread, Delay spread, and subcarrier spacing (SCS) may significantly simplify the calculating of q₁, and, therefore, of q. Doppler spread may be the spectral spreading of the signal as a result of time-varying range rate. Delay spread may be the spread in delay values due to time-varying range between the UE and the gNB, and subcarrier spacing may be the frequency interval between adjacent subcarriers of a component carrier (CC).

The CE error power, which may be used as part of the calculation of the log likelihood ratio, may be calculated as follows, assuming frequency domain LMMSE with time domain interpolation (TDI) (FD-LMMSE+TDI) channel estimation is applied using a general form of time domain interpolation.

As defined in Equation 6, q₂ is a function of rank and

$$λ = \frac{{σ}_{e}^{2}}{{σ}_{n}^{2}} .$$

In a two DMRS symbol case (the results are readily generalized to a case with more than two DMRS symbols), with tₛ denoting the DMRS symbol location, with s∈{0,1}, with ĥⱼ(t) denoting the channel estimate at the t-th OFDM symbol, where j denotes DMRS port index, with w denoting the FD-LMMSE filter weights for the j-th DMRS port, and v(t)=[v₀(t)v₁(t)] denoting the TDI weights used to obtain CE at the t-th OFDM symbol, an expression for σₑ² may be derived as follows. For FD-LMMSE the channel estimation output is

$${\tilde{h}}_{j} ( {t}_{s} ) = {w}_{j}^{H} y ( {t}_{s} ) ,$$

and by applying TDI, the final CE result at the t-th OFDM symbol may be obtained as

$${\hat{h}}_{j} ( t ) = ( {v}_{0} ( t ) {w}_{j}^{H} y ( {t}_{0} ) + {v}_{1} ( t ) {w}_{j}^{H} y ( {t}_{1} ) ) = {w}_{j}^{H} ( {v}_{0} ( t ) y ( {t}_{0} ) + {v}_{1} ( t ) y ( {t}_{1} ) ) .$$

Therefore, for CE error power after TDI,

$$\begin{matrix}{σ}_{e}^{2} = E \{ {\vert {h}_{j} ( t ) - {\hat{h}}_{j} ( t ) \vert}^{2} \} \\ = E \{ {\vert {h}_{j} ( t ) - {w}_{j}^{H} ( {v}_{0} ( t ) y ( {t}_{0} ) + {v}_{1} ( t ) y ( {t}_{1} ) ) \vert}^{2} \} \\ = \begin{matrix}{P}_{h} + {W}_{j}^{H} E \{ ( {v}_{0} ( t ) y ( {t}_{0} ) + {v}_{1} ( t ) y ( {t}_{1} ) ) {( {v}_{0} ( t ) y ( {t}_{0} ) + {v}_{1} ( t ) y ( {t}_{1} ) )}^{H} \} \\ {w}_{j} - 2 R e \{ {w}_{j}^{H} E \{ ( {v}_{0} ( t ) y ( {t}_{0} ) + {v}_{1} ( t ) y ( {t}_{1} ) ) {h}_{j}^{*} ( t ) \} \}\end{matrix}\end{matrix} \qquad ( 7 )$$

where P_{h,j}=E{|hⱼ(t)|²}.

Defining

$${γ}_{s} = {r}_{t} ( t - {t}_{s} )$$

and substituting

$$E \{ y ( {t}_{0} ) {y}^{H} ( {t}_{1} ) \} = γ ( {R}_{f} - {σ}_{n}^{2} I ) ,$$

$$E \{ y ( {t}_{s} ) {y}^{H} ( {t}_{s} ) \} = {R}_{f} ,$$

$$and$$

$$E \{ y ( {t}_{s} ) {h}_{j}^{*} ( t ) \} = {r}_{t} ( t - {t}_{s} ) {r}_{j} = {γ}_{s} {r}_{j} ,$$

it may be shown that

$${σ}_{{e}_{j}}^{2} ( t ) = {P}_{h} + ( {v}_{0}^{2} ( t ) + {v}_{1}^{2} ( t ) + 2 {v}_{0} ( t ) {v}_{1} ( t ) γ ) {w}_{j}^{H} {R}_{f} {w}_{j} - 2 {v}_{0} ( t ) {v}_{1} ( t ) γ {σ}_{n}^{2} {w}_{j}^{H} {w}_{j} - 2 ( {v}_{0} ( t ) {γ}_{0} + {v}_{1} ( t ) {γ}_{1} ) {w}_{j}^{H} {r}_{j} = {P}_{h} + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - 2 {v}_{1} ( t ) {γ}_{1} ) {w}_{j}^{H} {r}_{j} - 2 {v}_{0} ( t ) {v}_{1} ( t ) γ {σ}_{n}^{2} {w}_{j}^{H} {w}_{j} .$$

For normalized FD-LMMSE estimation error σ_{e,f}² (normalized w.r.t. Pₕ),

$${σ}_{e , f}^{2} = 1 - \frac{{w}_{j}^{H} {r}_{j}}{{P}_{h}} \to {w}^{H} {r}_{j} = {P}_{h} ( 1 - {σ}_{e , f}^{2} ) .$$

Averaging over all OFDM symbols (t∈{0, . . . , 13}), for the CE error power after TDI results in

$${σ}_{{e}_{j}}^{2} = \frac{1}{14} {\sum }_{t = 0}^{13} ( {P}_{h} + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - 2 {v}_{1} ( t ) {γ}_{1} ) {P}_{h} ( 1 - {σ}_{e , f}^{2} ) - 2 {v}_{0} ( t ) {v}_{1} ( t ) γ {σ}_{n}^{2} {P}_{{w}_{j}} ) ,$$

where P_{w}_{ⱼ}=wⱼ^{H}wⱼ. Therefore for

$${λ}_{j} = \frac{{σ}_{{e}_{j}}^{2}}{{σ}_{n}^{2}} ,$$

$${λ}_{j} = \frac{{σ}_{{e}_{j}}^{2}}{{σ}_{n}^{2}} = \frac{1}{14} {\sum }_{t = 0}^{13} \frac{\begin{matrix}{P}_{h} + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - \\ 2 {v}_{1} ( t ) {γ}_{1} ) {P}_{h} ( 1 - {σ}_{e , f}^{2} ) - 2 {v}_{0} ( t ) {v}_{1} ( t ) γ {σ}_{n}^{2} {P}_{{w}_{j}}\end{matrix}}{{σ}_{n}^{2}} .$$

Because Pₕ denotes the per port power over the DMRS REs, and because of the

structure of the frequency domain orthogonal cover codes (FD-OCC),

$$SNR = \{ \begin{matrix}\frac{{P}_{h}}{{σ}_{n}^{2}} & 1 DMRS port \\ \frac{2 {P}_{h}}{{σ}_{n}^{2}} & 2 or 4 DMRS ports \\ \frac{2 {P}_{{h}_{0}}}{{σ}_{n}^{2}} = \frac{2 {P}_{{h}_{1}}}{{σ}_{n}^{2}} = \frac{{P}_{{h}_{2}}}{{σ}_{n}^{2}} & 3 DMRS ports\end{matrix}$$

Therefore, averaging over all ports, it may be shown that

$$λ = \frac{1}{\# ports} \sum {λ}_{j} = s c {l}_{1} \times SNR - offset$$

with

$$offset = \frac{1}{\# ports} \sum \frac{1}{14} {\sum }_{t} 2 {v}_{0} ( t ) {v}_{1} ( t ) γ {P}_{{w}_{j}}$$

where scl₁ takes one of the following values, depending on the number of DMRS ports:

for one DMRS port:

$$s c {l}_{1} = \frac{1}{14} {\sum }_{t = 0}^{13} 1 + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - 2 {v}_{1} ( t ) {γ}_{1} ) ( 1 - {σ}_{e , f}^{2} ) ,$$

for two or four DMRS ports:

$$s c {l}_{1} = \frac{1}{14} {\sum }_{t = 0}^{13} \frac{1 + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - 2 {v}_{1} ( t ) {γ}_{1} ) ( 1 - {σ}_{e , f}^{2} )}{2} ,$$

and for three DMRS ports:

$$s c {l}_{1} = \frac{1}{14} {\sum }_{t = 0}^{13} \frac{1 + ( {v}_{0}^{2} ( t ) + {v}_{1}^{2} ( t ) + 2 {v}_{0} ( t ) {v}_{1} ( t ) γ - 2 {v}_{0} ( t ) {γ}_{0} - 2 {v}_{1} ( t ) {γ}_{1} ) ( 1 - {σ}_{e , f}^{2} )}{1.5}$$

It may be seen that each of the expressions for scl₁ (and, therefore, the expression for the CE error power σₑ²) is based on (e.g., depends on) (i) a weight for time domain interpolation (e.g., v₀) and (ii) on a correlation time (γ) of a channel response of a channel corresponding to the channel estimation error.

In some embodiments, as mentioned above, a UE 105 may calculate log likelihood ratios for a received transmission (e.g. a PDSCH transmission), in a manner that reduces or avoids the presence of CE error-related bias in the log likelihood ratios. The UE 105 may accomplish this using one of the methods disclosed herein, e.g., by calculating an uncorrected log likelihood ratio and adjusting the uncorrected log likelihood ratio by one or more correction mappings (e.g., additive or multiplicative correction mappings). FIG. 2 shows such a method, in some embodiments. The UE 105 may receive, at 205, a reference signal; the UE 105 may generate, at 210, a channel estimate, based on the reference signal; the UE 105 may determine, at 215, a channel estimation error metric for the channel estimate; the UE 105 may receive, at 220, a transmission (e.g. a PDSCH transmission); the UE 105 may calculate, at 225, a log likelihood ratio, based on the channel estimation error metric, for each of a plurality of bit positions of the transmission; and the UE 105 may decode the transmission based on the log likelihood ratio.

As mentioned above, the calculating of the log likelihood ratio by the UE 105 may include calculating a corrected log likelihood ratio equal to an uncorrected log likelihood ratio adjusted by one or more correction mappings. For example, the uncorrected log likelihood ratio may be adjusted by a multiplicative correction mapping. The multiplicative correction factor used in the multiplicative correction mapping may be equal to (e.g., it may be rounded to be equal to) 2 raised to the power of an integer; in such an embodiment the computational cost of applying the multiplicative correction may be reduced, because the applying of the multiplicative correction mapping may correspond (i) to a shift if the log likelihood ratio is represented using a fixed-point representation, or (ii) to a change in the exponent if the log likelihood ratio is represented using a floating-point representation. In some embodiments, the log likelihood ratio is stored in a fixed-point representation, the fixed-point representation having a binary point position calculated as a sum of a first term and a second term. The second term may be the integer to the power of which 2 is raised, in an embodiment in which the multiplicative correction factor is equal to 2 raised to the power of an integer.

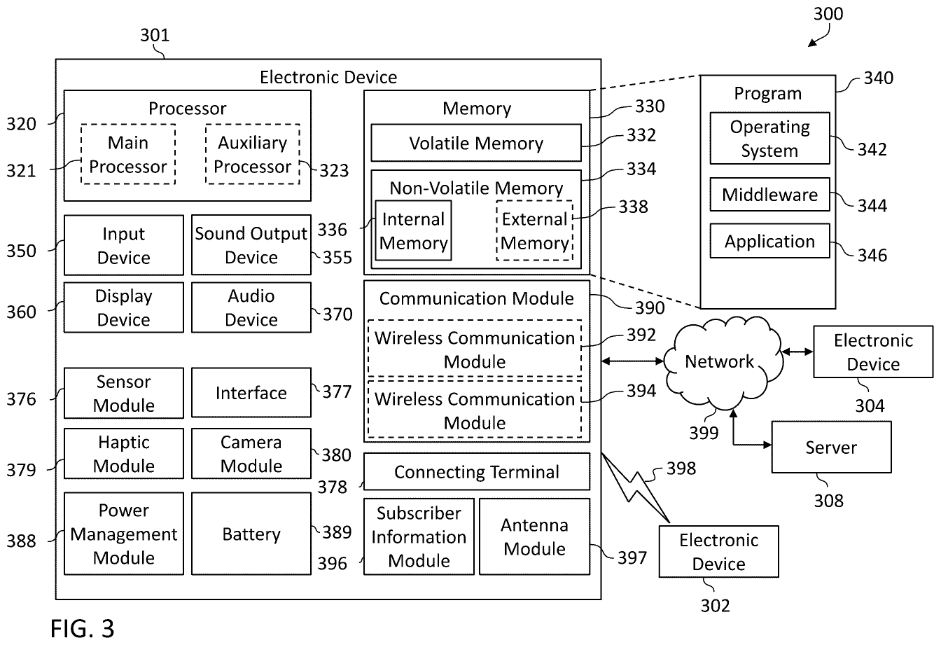

FIG. 3 is a block diagram of an electronic device 301, e.g., a UE 105, in a network environment 300, according to an embodiment. The electronic device 301 may (e.g., a processing circuit of the electronic device 301 may) perform some or all of the methods disclosed herein.

Referring to FIG. 3, an electronic device 301 in a network environment 300 may communicate with an electronic device 302 via a first network 398 (e.g., a short-range wireless communication network), or an electronic device 304 or a server 308 via a second network 399 (e.g., a long-range wireless communication network). The electronic device 301 may communicate with the electronic device 304 via the server 308. The electronic device 301 may include a processor 320, a memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) card 396, or an antenna module 397. In one embodiment, at least one (e.g., the display device 360 or the camera module 380) of the components may be omitted from the electronic device 301, or one or more other components may be added to the electronic device 301. Some of the components may be implemented as a single integrated circuit (IC). For example, the sensor module 376 (e.g., a fingerprint sensor, an iris sensor, or an illuminance sensor) may be embedded in the display device 360 (e.g., a display).

The processor 320 may execute software (e.g., a program 340) to control at least one other component (e.g., a hardware or a software component) of the electronic device 301 coupled with the processor 320 and may perform various data processing or computations.

As at least part of the data processing or computations, the processor 320 may load a command or data received from another component (e.g., the sensor module 376 or the communication module 390) in volatile memory 332, process the command or the data stored in the volatile memory 332, and store resulting data in non-volatile memory 334. The processor 320 (or “processing circuit” or “means for processing”) may include a main processor 321 (e.g., a central processing unit (CPU) or an application processor (AP)), and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321, or execute a particular function. The auxiliary processor 323 may be implemented as being separate from, or a part of, the main processor 321.

The auxiliary processor 323 may control at least some of the functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). The auxiliary processor 323 (e.g., an image signal processor or a communication processor) may be implemented as part of another component (e.g., the camera module 380 or the communication module 390) functionally related to the auxiliary processor 323.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334. Non-volatile memory 334 may include internal memory 336 and/or external memory 338.

The program 340 may be stored in the memory 330 as software, and may include, for example, an operating system (OS) 342, middleware 344, or an application 346.

The input device 350 may receive a command or data to be used by another component (e.g., the processor 320) of the electronic device 301, from the outside (e.g., a user) of the electronic device 301. The input device 350 may include, for example, a microphone, a mouse, or a keyboard.

The sound output device 355 may output sound signals to the outside of the electronic device 301. The sound output device 355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 360 may visually provide information to the outside (e.g., a user) of the electronic device 301. The display device 360 may include, for example, a display, a hologram device, or a projector and control circuitry to control a corresponding one of the display, hologram device, and projector. The display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. The audio module 370 may obtain the sound via the input device 350 or output the sound via the sound output device 355 or a headphone of an external electronic device 302 directly (e.g., wired) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. The sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device 302 directly (e.g., wired) or wirelessly. The interface 377 may include, for example, a high-definition multimedia interface (HDMI), a universal serial bus (USB) interface, a secure digital (SD) card interface, or an audio interface.

A connecting terminal 378 may include a connector via which the electronic device 301 may be physically connected with the external electronic device 302. The connecting terminal 378 may include, for example, an HDMI connector, a USB connector, an SD card connector, or an audio connector (e.g., a headphone connector).

The haptic module 379 may convert an electrical signal into a mechanical stimulus (e.g., a vibration or a movement) or an electrical stimulus which may be recognized by a user via tactile sensation or kinesthetic sensation. The haptic module 379 may include, for example, a motor, a piezoelectric element, or an electrical stimulator.

The camera module 380 may capture a still image or moving images. The camera module 380 may include one or more lenses, image sensors, image signal processors, or flashes. The power management module 388 may manage power supplied to the electronic device 301. The power management module 388 may be implemented as at least part of, for example, a power management integrated circuit (PMIC).

The battery 389 may supply power to at least one component of the electronic device 301. The battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the AP) and supports a direct (e.g., wired) communication or a wireless communication. The communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as BLUETOOTH™, wireless-fidelity (Wi-Fi) direct, or a standard of the Infrared Data Association (IrDA)) or the second network 399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The antenna module 397 may transmit or receive a signal or power to or from the outside (e.g., the external electronic device) of the electronic device 301. The antenna module 397 may include one or more antennas, and, therefrom, at least one antenna appropriate for a communication scheme used in the communication network, such as the first network 398 or the second network 399, may be selected, for example, by the communication module 390 (e.g., the wireless communication module 392). The signal or the power may then be transmitted or received between the communication module 390 and the external electronic device via the selected at least one antenna.

Commands or data may be transmitted or received between the electronic device 301 and the external electronic device 304 via the server 308 coupled with the second network 399. Each of the electronic devices 302 and 304 may be a device of a same type as, or a different type, from the electronic device 301. All or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving a reference signal;
generating a channel estimate, based on the reference signal;
determining a channel estimation error metric for the channel estimate;
receiving a transmission;
calculating a log likelihood ratio, based on the channel estimation error metric, for each of a plurality of bit positions of the transmission; and
decoding the transmission based on the log likelihood ratio,
wherein the calculating of the log likelihood ratio comprises calculating a corrected log likelihood ratio based at least on an uncorrected log likelihood ratio.

2. The method of claim 1, wherein the corrected log likelihood ratio is further equal to the uncorrected log likelihood ratio further adjusted by one or more correction mappings.

3. The method of claim 2, wherein a first correction mapping of the correction mappings is based on a multiplicative correction mapping.

4. The method of claim 3, wherein the first correction mapping of the correction mappings comprises multiplication by 2 raised to the power of an integer.

5. The method of claim 4, further comprising storing the log likelihood ratio in a fixed-point representation, the fixed-point representation having a binary point position calculated based on a first term and a second term, the second term being the integer.

6. The method of claim 3, wherein the first correction mapping is based on a rank of the transmission.

7. The method of claim 6, wherein the first correction mapping is based on the channel estimation error metric.

8. The method of claim 7, wherein the channel estimation error metric is based on a ratio of a channel estimation error power to a noise power.

9. The method of claim 8, wherein the determining of the channel estimation error metric comprises determining the channel estimation error power based on a weight for time domain interpolation.

10. The method of claim 9, wherein the determining of the channel estimation error metric comprises determining the channel estimation error power further based on a correlation time of a channel response of a channel corresponding to the channel estimation error.

11. A system, comprising:
one or more processors; and
a memory storing instructions which, when executed by the one or more processors, cause performance of:
receiving a reference signal;
generating a channel estimate, based on the reference signal;
determining a channel estimation error metric for the channel estimate;
receiving a transmission;
calculating a log likelihood ratio, based on the channel estimation error metric, for each of a plurality of bit positions of the transmission; and
decoding the transmission based on the log likelihood ratio,
wherein the calculating of the log likelihood ratio comprises calculating a corrected log likelihood ratio based at least on an uncorrected log likelihood ratio.

12. The system of claim 11, wherein the corrected log likelihood ratio is further equal to the uncorrected log likelihood ratio further adjusted by one or more correction mappings.

13. The system of claim 12, wherein a first correction mapping of the correction mappings is based on a multiplicative correction mapping.

14. The system of claim 13, wherein:
the first correction mapping of the correction mappings comprises multiplication by 2 raised to the power of an integer; and
the instructions, when executed by the one or more processors, further cause performance of storing the log likelihood ratio in a fixed-point representation, the fixed-point representation having a binary point position calculated based on a first term and a second term, the second term being the integer.

15. The system of claim 13, wherein the first correction mapping is based on a rank of the transmission.

16. The system of claim 15, wherein the first correction mapping is based on the channel estimation error metric.

17. The system of claim 16, wherein the channel estimation error metric is based on a ratio of a channel estimation error power to a noise power.

18. The system of claim 17, wherein the determining of the channel estimation error metric comprises determining the channel estimation error power based on a weight for time domain interpolation.

19. The system of claim 18, wherein the determining of the channel estimation error metric comprises determining the channel estimation error power further based on a correlation time of a channel response of a channel corresponding to the channel estimation error.

20. A system, comprising:
means for processing; and
a memory storing instructions which, when executed by the means for processing, cause performance of:
receiving a reference signal;
generating a channel estimate, based on the reference signal;
determining a channel estimation error metric for the channel estimate;
receiving a transmission;
calculating a log likelihood ratio, based on the channel estimation error metric, for each of a plurality of bit positions of the transmission; and
decoding the transmission based on the log likelihood ratio,
wherein the calculating of the log likelihood ratio comprises calculating a corrected log likelihood ratio based at least on an uncorrected log likelihood ratio.
